(19) United States
(12) Patent Application Publication
(10) Pub. No.: US 2001/0042654 A1
(43) Pub. Date: Nov. 22, 2001

(54) Load carrying machine

(76) Inventors: Simon John Ratcliffe, Denstone (GB); Kenneth Edward Walton, Stoke-on-Trent (GB); Graham Deavall, Leek (GB)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(21) Appl. No.: 09/850,023

(22) Filed: May 7, 2001

(30) Foreign Application Priority Data
May 13, 2000 (GB) 0011471.0

(51) Int. Cl. B60K 17/00

(52) U.S. Cl. 180/349

(57) ABSTRACT

A load carrying machine has a front and a rear part, the front part having a front frame, an engine mounted in or on the front frame, a front axle carrying ground engaging wheels, a transmission for transmitting drive from the engine to the ground engaging wheels, an operator's work station from where the machine is in use, controlled, and the rear part having a rear frame and a ground engaging wheels, and a container for containing matter to be transported, the front and rear parts of the being connected by a which permits of relative movement between the front and rear parts about a first generally upright axis, and about a horizontal which, when the front and rear parts are generally aligned about the upright axis, extends generally longitudinally of the machine and wherein the front axle is suspended from the front frame.

### BACKGROUND OF THE INVENTION

This invention relates to a load carrying machine and more particularly to a machine of the kind known as a dump truck.

A dump truck typically has a front part complete with an operator's cab or other work station, and an engine, and a rear part on which there is provided a container into which matter such as earth, hard-core, minerals, crops or the like may be dumped by for example, a loading machine. The rear part may be connected to the front part by a joint which permits of relative movement between the front and rear parts about a first generally upright axis, and about a generally horizontal axis which, when the first and second parts are generally aligned about the upright axis, extends generally longitudinally of the machine. Thus the machine is articulated, steering being effected by articulating the front part relative to the rear part.

The rear part typically has an axle which is rigid with a frame of the rear part, and the front part has an axle which is rigid with a frame of the front part. Thus in response to irregularities in the ground, the front and rear parts may relatively move about the horizontal axis of the joint between the two parts. Thus where the axles each carry a wheel at each end, four wheel contact with the ground may be maintained even on rough terrain.

### SUMMARY OF THE PRIOR ART

Such a machine provides little comfort for an operator. Typically the only means of absorbing shocks is in the operator's seat. Moreover, although such a machine may operate satisfactorily on rough terrain at generally slow speeds, because no suspension is provided, the machine is only able to move relatively slowly on-road.

### SUMMARY OF INVENTION

According to the present invention we provide a load carrying machine having a front part and a rear part, the front part having a front frame, an engine mounted in or on the front frame, a front axle carrying ground engaging wheels, a transmission for transmitting drive from the engine to the ground engaging wheels, an operator's work station from where the machine is in use, controlled, and the rear part having a rear frame, and ground engaging wheels, and a container for containing matter to be transported, the front and rear parts of the machine being connected by a joint which permits of relative movement between the front and rear parts about a first generally upright axis, and about a horizontal axis which, when the front and rear parts are generally aligned about the upright axis, extends generally longitudinally of the machine, and wherein the front axle is suspended from the front frame by a suspension which includes a pair of links at either side of the body, one link of each pair being above the other relative to the ground, the upper link of each pair being pivotally connected at a first end relative to the front frame and at a second end to the axle at a first position and the lower link of each pair being pivotally connected at a first end relative to the front frame and at a second end to the axle at a second position.

By providing the front part of the machine with such a suspension, several advantages have been realised.

First, comfort for an operator is improved as the suspension may absorb shocks. Second, faster on-road speeds may be attained. Moreover, the stability of the rear part of the machine on which matter is transported in the container, is not affected and utilising a suitable suspension, improved handling on rough off-road terrain may be attained as some shocks/loads on the front part may be absorbed by the suspension instead of being transmitted to the rear part.

Preferably the links lead from their first positions to their second positions in a direction of forward travel of the machine.

Such a suspension is non-reactive in that there is no significant change in the vertical loading on the ground engaging means of the front part in response to changes in the driving torque applied thereto.

Thus drive may be transmitted from the power operated motive means to the ground via ground engaging means such as wheels.

The front axle suspension may include a Panhard rod which extends laterally of the machine and is connected at one end to the front frame, and at the other end to the front axle.

To damp movement of the front axle relative to the front frame the suspension may include a hydraulic strut at each side of the front frame of the machine, movement of a piston in the strut being damped by a gas spring.

If desired a level sensing means may be provided to sense the distance between the front axle and the front frame at the respective sides of the machine, and there being a height regulating means for each level sensing means which is responsive to the respective level sensing means to adjust the distance between the axle at the respective side of the machine and the front frame to a datum distance.

Preferably the rear axle is generally rigidly attached to the rear frame as in a conventional machine, whereby in response to irregularities in the ground, the rear part may move relative to the front part of the machine about the generally horizontal axis.

In one embodiment the front frame part may include a pair of generally longitudinally extending chassis members, and a sub-frame interconnecting the chassis members, the engine being mounted on the front frame towards a first side of the front frame, and the operator's station being positioned towards an opposite side of the front frame.

Although only the ground engaging means of the front of the machine may be driven, if desired the transmission may be arranged to transmit drive from the engine to the rear wheels e.g. via the joint connecting the front and rear machine parts.

In a typical machine to which the invention may be applied, the container is open topped and is tippable relative to the rear part of the machine to enable matter contained thereby to be discharged therefrom. For example the container may be tippable about a generally horizontal axis which lies transverse to the longitudinal axis of the rear part of the machine. However, if desired the container need not be open topped, but could be a tank of the like containing e.g. a liquid to be discharged therefrom e.g. by spraying.

### BRIEF DESCRIPTION OF THE DRAWINGS

The invention will now be described with reference to the accompanying drawings in which

FIG. 1 is a side illustrative view of a load carrying machine in accordance with the present invention;

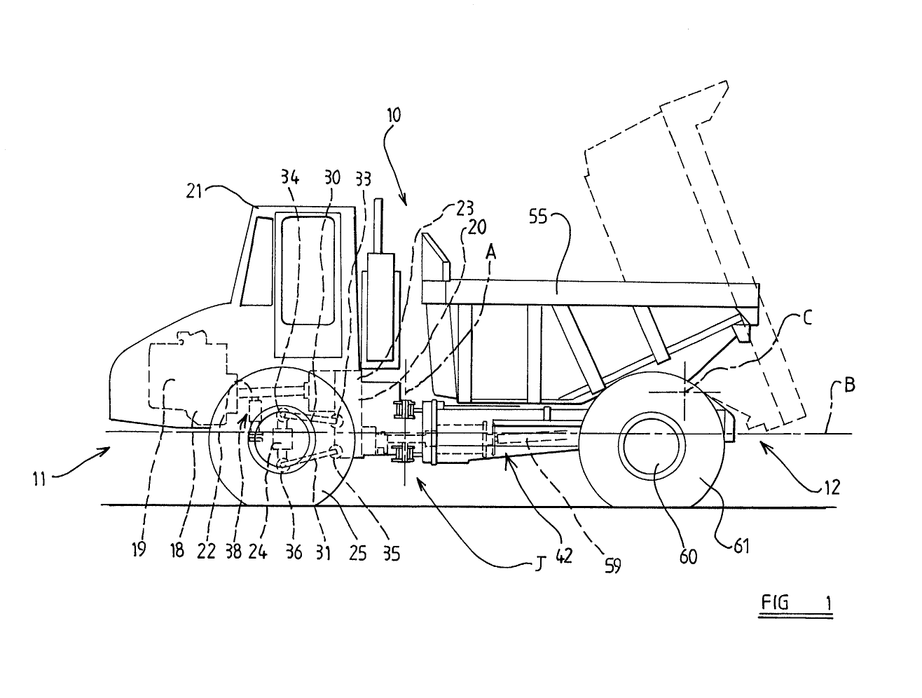

FIG. 2 is a more detailed fragmentary underside view of part of the machine of FIG. 1 with parts omitted for clarity.

### DESCRIPTION OF THE PREFERRED EMBODIMENTS

Referring to the drawings, a load carrying machine 10 of the kind known as an articulated dump truck is shown. The machine has a front part 11 connected to a rear part 12 as hereinafter described.

The front part 11 includes a front frame or chassis 15, having a pair of generally parallel longitudinally extending chassis members 16, interconnected towards a front of the front part 11 by a front sub-frame 18. The sub-frame 18 carries a power operated propulsion means 19 which in this case is a diesel engine, and a transmission including a gearbox 20 to which drive is transmitted from the engine 19 via a propeller shaft 27, is carried on a rear sub-frame 23 which also inter connects the chassis members 16. The engine 19 is carried centrally of the machine 10, and towards a side of the machine 10 slightly rearwardly of the engine 19, there is provided an operator's station including a cab 21 from which the machine 10 may be controlled. The gearbox 20 is generally centrally located.

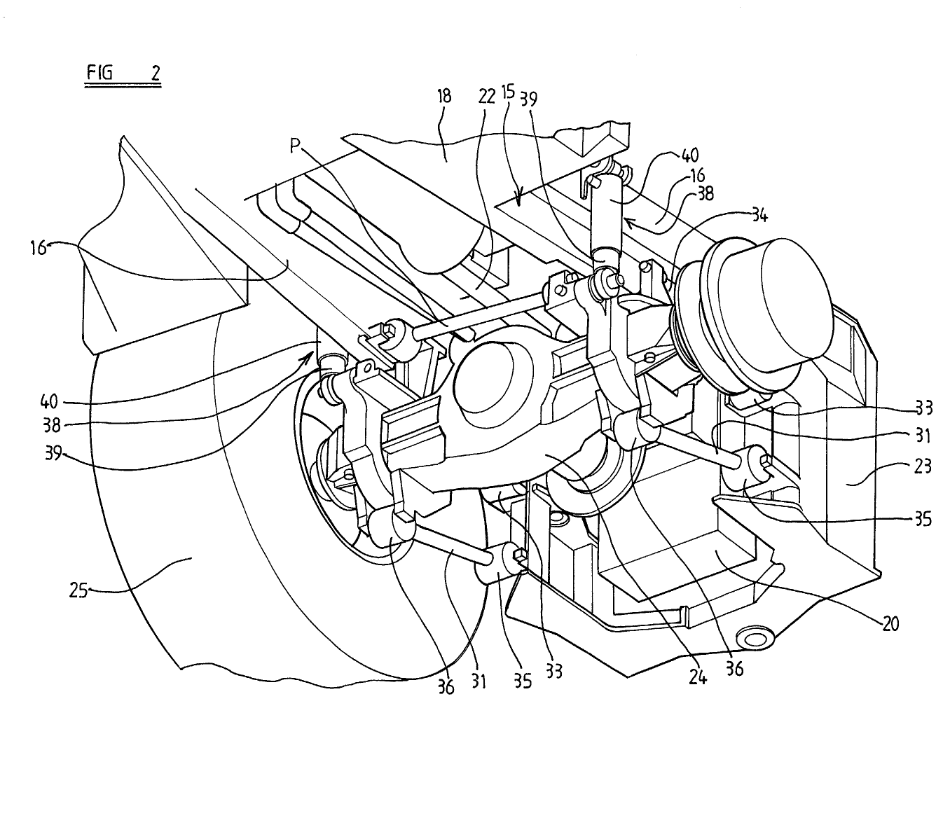

Below the chassis members 16 there is provided a front axle 24 adapted to carry at the outer ends thereof, ground engaging means being wheels 25 one of which is omitted in FIG. 2, for clarity. Drive is transmitted from the gearbox 20 of the transmission to the wheels 25 via the axle 24 as is well known in the art.

In accordance with the present invention, the front axle 24 is suspended from the chassis 15. The suspension includes a pair of links 30, 31 arranged one 30 above the other 31 at each side of the machine 10, the links 30, 31 being leading links. The upper links 30 are pivotally attached at their one ends 33 to the rear sub-frame 23, and at their second opposite ends 34 to the axle 24. Similarly the lower links 31 are pivotally attached at their one ends 35 to the sub-frame 18 and at their second opposite ends 36 to the axle 24. The one ends 33 of the upper links 30 are positioned at a level above the one ends 35 of the lower links 31, and the opposite ends 34 of the upper links 30 are positioned at a level above the opposite ends 34 of the lower links 31.

Also, between the axle 24 and the chassis 15, there are provided hydraulic struts 38, in this example, one at each side of the machine 10, pistons 39 of the struts 38 being connected to the axle 24 and cylinders 40 thereof to the front sub frame 18 of the chassis 15.

Hydraulic fluid may flow to and from the cylinders 40 in response to axle 24 movements relative to the chassis 15 in response to ground irregularities. The hydraulic fluid is transmitted to respective gas springs (not shown) which contain a diaphragm behind which trapped gas provides damping as hydraulic fluid is transmitted to the springs from the struts 38.

The front axle 24 suspension further includes a Panhard rod P which extends transversely of the chassis member 16, and is connected at one end relative to one of the chassis members 16, and at the other end relative to the front axle 24.

If desired a level sensing means may be provided to sense the distance between the front axle and the front frame at the respective sides of the machine, and there being a height regulating means for each level sensing means which is responsive to the respective level sensing means to adjust the distance between the axle at the respective side of the machine and the front frame to a datum distance.

The rear part 12 also has a chassis 42 which may include a pair of chassis members on which there is mounted a container 55 which, in this example is an open topped container into which matter may be dumped, for example by a loader machine.

The container 55 may be tippable relative to the chassis 42 about a generally horizontal axis C which extends generally perpendicularly to a longitudinal axis B of the rear part 12 of the machine 10.

Thus there may be provided one or more actuators such as hydraulic rams or alternatively electrical means to tip the container 55 to enable the container 55 contents to be discharged.

Below the chassis 42 of the rear part 12 there is provided an axle 60 which carries at the ends thereof, ground engaging means being a pair of wheels 61. The wheels preferably are driven wheels, drive being transmitted thereto from the engine 19 of the front part 11 of the machine 10 via a drive shaft 59 from the gearbox 20.

The axle 60 of the rear part 12 is provided rigidly with the rear frame 42.

The front 11 and rear parts 12 are connected together by a joint J which permits of relative movement between the front 11 and rear 12 parts about a generally upright axis A so that the front 11 and rear parts 12 are articulated to enable the machine 10 to be steered, and about a horizontal axis B which, when the first 11 and second 12 parts are generally aligned about the upright axis A as seen in the drawing, extends generally longitudinally of the machine 10.

Thus in the event that a ground irregularity causes one of the rear wheels 61 to lift, the rear part 12 may move relative to the front part 11 about the horizontal axis B, so that both rear wheels 61 may be maintained in contact with the ground. Steering is effected by operating one or more hydraulic actuators not shown, which extend between the front 11 and rear 12 parts, as is well known in the art.

By virtue of the front part 11 having a suspended front axle 24, shocks experienced by the front part 11 of the machine 10 need not be transmitted to the operator in the operator's station 21, or to the rear part 12 thus maintaining the stabilisation of the rear part 12.

Various modifications may be made without departing from the scope of the invention.

For example the particular geometry of the machine may be different to that shown, for example with the operator's cab 21 positioned more centrally of the front part 11 of the machine, and with the engine 19 positioned more towards the front or rear of the front part 11.

The container 55 of the rear part 12 of the machine need not be open topped and tippable as described with reference to the example of the drawing, but may be for example a tank for a liquid load. The container need not be an integral part of the rear part 12 of the machine 10 but may be a load carried by the rear frame 42.

Although in the example described, the rear part 12 has an axle 60 carrying wheels 61, in another arrangement, a ground engaging means which may be wheels 61 or even tracks, may otherwise be carried by the rear part 12.

Although in the example described, the rear axle 60 is rigid with the rear frame 42, in another example, to facilitate travelling on-road for example, this may be suspended, although to maintain stability during load handling, such suspension may need to be locked out.

1. A load carrying machine having a front part and a rear part, the front part having a front frame, an engine mounted in or on the front frame, a front axle carrying ground engaging wheels, a transmission for transmitting drive from the engine to the ground engaging wheels, an operator's work station from where the machine is in use, controlled, and the rear part having a rear frame and ground engaging wheels, and a container for containing matter to be transported, the front and rear parts of the machine being connected by a joint which permits of relative movement between the front and rear parts about a first generally upright axis, and about a horizontal axis which, when the front and rear parts are generally aligned about the upright axis, extends generally longitudinally of the machine, and wherein the front axle is suspended from the front frame by a suspension which includes a pair of links at either side of the body, one link of each pair being above the other relative to the ground, the upper link of each pair being pivotally connected at a first end relative to the front frame and at a second end to the front axle at a first position and the lower link of each pair being pivotally connected at a first end relative to the front frame and at a second end to the front axle at a second position.

2. A machine according to claim 2 wherein the links lead from their first positions to their second positions in a direction of forward travel of the machine.

3. A machine according to claim 1 wherein the suspension is non-reactive in that in that there is no significant change in the vertical loading on the ground engaging wheels of the front part in response to changes in the driving torque applied thereto.

5. A machine according to claim 1 wherein to damp movement of the front axle relative to the front frame the suspension includes a hydraulic strut at each side of the front frame of the machine.

5. A machine according to claim 1 wherein the rear axle is generally rigidly attached to the rear frame whereby in response to irregularities in the ground, the rear part may move relative to the front part of the machine about a generally horizontal axis.

6. A machine according to claim 1 wherein the front frame part includes a pair of generally longitudinally extending chassis members, and a sub-frame interconnecting the chassis members, the engine being mounted on the front frame towards a first side of the front frame, and the operator's station being positioned towards an opposite side of the front frame.

7. A machine according to claim 1 wherein the container is open topped and is tippable relative to the rear part of the machine to enable matter contained thereby to be discharged therefrom.

8. A machine according to claim 7 wherein the container is tippable about a generally horizontal axis which lies transverse to a the longitudinal axis of the rear part of the machine.
